(19) United States
(12) Patent Application Publication
(10) Pub. No.: US 2024/0339122 A1
(43) Pub. Date: Oct. 10, 2024

(54) SYSTEMS AND METHODS FOR ANY TO ANY VOICE CONVERSION

(71) Applicant: Datum Point Labs Inc., Jackson, WY (US)

(72) Inventors: Donghyeon Kim, Seoul (KR); Bonhwa Ku, Seoul (KR); Hanseok Ko, Seoul (KR)

(21) Appl. No.: 18/608,476

(22) Filed: Mar. 18, 2024

Related U.S. Application Data
(60) Provisional application No. 63/457,596, filed on Apr. 6, 2023.

(51) Int. Cl. G10L 21/007; G10L 15/06; G10L 15/08

(52) U.S. Cl. CPC G10L 21/007; G10L 15/063; G10L 15/08; G10L 2015/0635

(57) ABSTRACT

Embodiments described herein provide systems and methods for any to any voice conversion. A system receives, via a data interface, a source utterance of a first style and a target utterance of a second style. The system generates, via a first encoder, a vector representation of the target utterance. The system generates, via a second encoder, a vector representation of the source utterance. The system generates, via a filter generator, a generated filter based on the vector representation of the target utterance. The system generates, via a decoder, a generated utterance based on the vector representation of the source utterance and the generated filter.

### CROSS REFERENCE(S)

The instant application is a nonprovisional of and claim priority under 35 U.S.C. 119 to U.S. provisional application No. 63/457,596, filed Apr. 6, 2023, which is hereby expressly incorporated by reference herein in its entirety.

### TECHNICAL FIELD

The embodiments relate generally to systems and methods for any to any voice conversion.

### BACKGROUND

Voice Conversion (VC) is a speech style transformation technique in which an utterance in one style (i.e., in a specific voice) is modified to another target style. Existing methods rely on models trained for specific source and target styles. These methods do not lend themselves to allowing for voice conversion between “blind” speakers, that do not belong to the training dataset for the models. Therefore, there is a need for improved systems and methods for voice conversion from any speaker to any speaker.

### BRIEF DESCRIPTION OF THE DRAWINGS

FIG. 1 illustrates a framework for voice conversion, according to some embodiments.

FIG. 2A is a simplified diagram of an exemplary filter generator, according to some embodiments.

FIG. 2B is a simplified diagram of an exemplary attentive pooling model, according to some embodiments.

FIG. 3 is a simplified diagram illustrating a computing device implementing the framework described herein, according to some embodiments.

FIG. 4 is a simplified diagram illustrating a neural network structure, according to some embodiments.

FIG. 5 is a simplified block diagram of a networked system suitable for implementing the framework described herein.

FIG. 6 is an example logic flow diagram, according to some embodiments.

FIGS. 7A-7B are exemplary devices with digital avatar interfaces, according to some embodiments.

FIGS. 8-11 provide charts illustrating exemplary performance of different embodiments described herein.

### DETAILED DESCRIPTION

Voice Conversion (VC) is a speech style transformation technique in which an utterance in one style (i.e., in a specific voice) is modified to another target style. Existing methods rely on models trained for specific source and target styles. These methods do not lend themselves to allowing for voice conversion between “blind” speakers, that do not belong to the training dataset for the models. In view of the need for improved systems and methods for voice conversion from any speaker to any speaker, embodiments described herein include Discriminative, Dynamic, and Domain-guided Voice Conversion (D3VC). The methods described herein include a generative adversarial network (GAN) based high-quality voice-to-voice conversion framework for Any-To-Any VC. In some embodiments, three main algorithms are applied in training the voice conversion model. First, a Dynamic Style Embedding (DSE) may be utilized to extract robust style features for blind target utterances. Second, an AAM SoftMax-based source classifier may be utilized for GAN training to enhance the learning process of GAN. Finally, domain-guided learning may be utilized to eliminate the speaker traits and spoken style of the source utterance. These three terms of contributions significantly enhance the performance of VC without heavy-weight modeling and text scripts.

Embodiments described herein provide a number of benefits. For example, voice conversion may be accurately performed for unseen target utterance without training a model (i.e., updating model parameters) for the specific target utterance. Dynamic style embedding may be performed as described herein, generating dynamic filters to represent target utterance style in a way that may be applied to a source utterance (e.g., via AdaIN). A large (unbounded) number of target utterances/voices may be targeted without training or storing large numbers of style representations, allowing for more efficient memory and computation utilization. This results in fewer computation and/or memory resources required to perform the task.

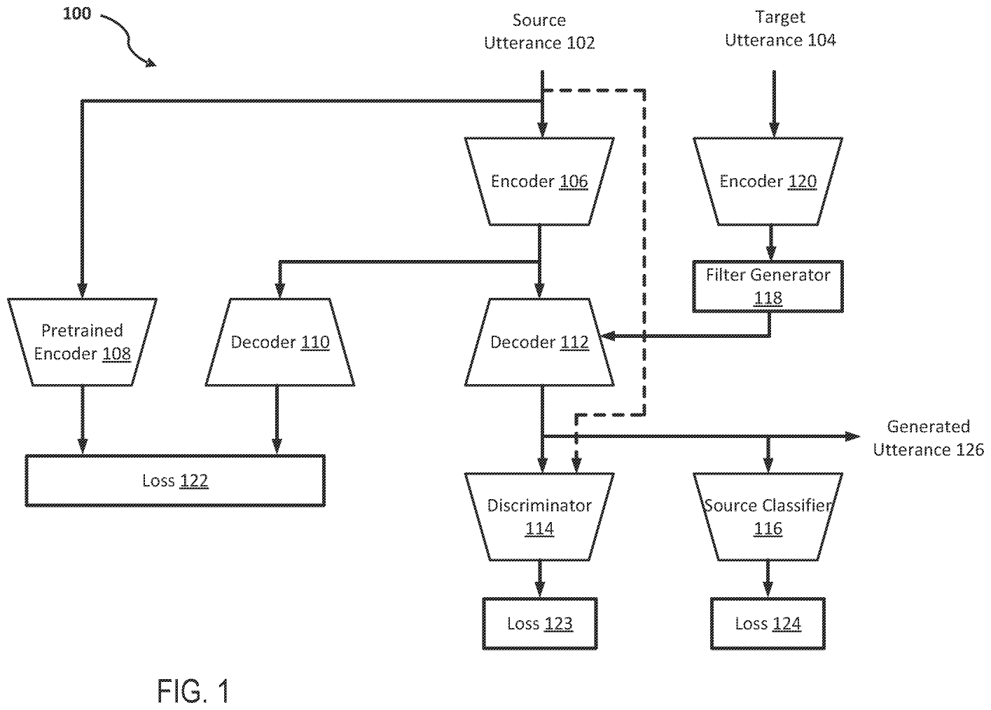

FIG. 1 illustrates an exemplary framework 100 for voice conversion, according to some embodiments. Framework 100 receives a source utterance 102, and target utterance 104. Source utterance 102 may be, for example, an audio recording of a first person speaking, and target utterance 104 may be another audio recording of a second person speaking. Source utterance 102 and/or target utterance 104 may be in the form of a waveform, a spectrogram, a Mel-Spectrogram, or any other suitable format for an audio utterance. The objective of the framework is to generate an output generated utterance 126 that modifies the source utterance 102 to be in the voice of the target utterance 104. Generated utterance 126 may be in the form of a waveform, a spectrogram, a Mel-Spectrogram, or any other suitable format for an audio utterance. In embodiments where generated utterance 126 is a spectrogram or Mel-Spectrogram, framework 100 may also include a vocoder that converts the spectrogram or Mel-Spectrogram to a playable audio waveform.

Source utterance 102 may be converted to a vector representation via encoder 106, and target utterance 104 may be converted to a vector representation via encoder 120. Encoder 120 may be a frozen pretrained model. In some embodiments, encoder 120 may be implemented as a densely connected 1D convolutional neural network (CNN) layers and attentive pooling with linear layers. For example, encoder 120 may be an ECAPA-TDNN model as described in Desplanques et al., ECAPA-TDNN: Emphasized channel attention, propagation and aggregation in tdnn based speaker verification, Proc. Interspeech, pp. 3830-3834, 2020. Encoder 120 may produce, for example, a 192-dimensional speaker embedding.

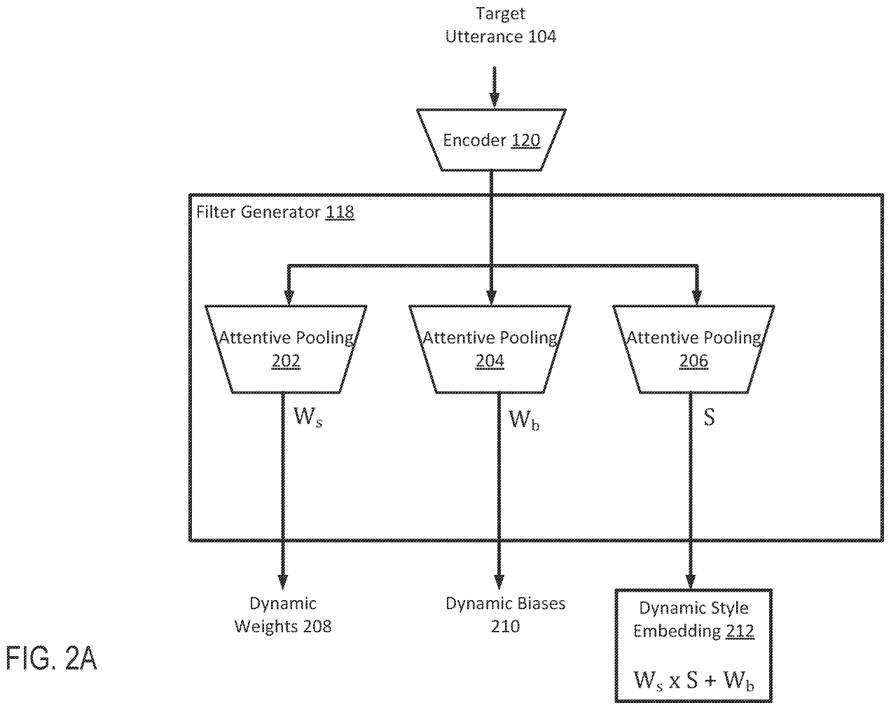

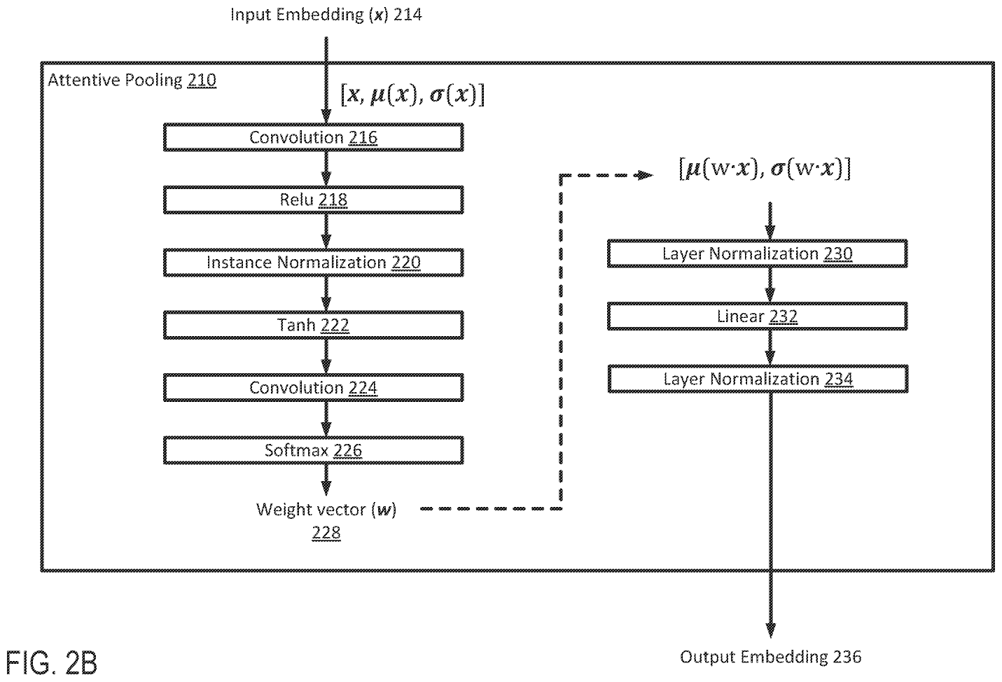

The vector representation of target utterance 104 may be input to a filter generator 118 to generate a filter which may be a dynamic style embedding representing the style aspects of target utterance 104 in a manner that it may be used to apply that style to source utterance 102. Additional details of an exemplary filter generator 118 are described in FIGS. 2A-2B. Decoder 112 may take the vector representation of source utterance 102 as an input, and the dynamic style embeddings as a second input for conditioning the decoding of the vector representation of source utterance 102 with the style of target utterance 104 to produce generated utterance 126. In some embodiments, at inference, encoder 106, encoder 120, filter generator 118, and decoder 112 are sufficient to produce generated utterance 126. The additional features of framework 100 described below may be used in training one or more of the components utilized in inference.

One or more loss functions may be computed for training one or more of the components of framework 100 to update their parameters via backpropagation. The losses described below may be used individually, or in combination (e.g., by weighting and summing the losses together). Other losses may be included in training of components of framework 100 in addition to those described below.

Loss 122 may represent “domain guided learning” (DGL). At a high level, the goal of DGL is to train encoder 106 to capture linguistic features of the source utterance 102 by eliminating the spoken style. Loss 122 may be generated based on outputs of a pretrained encoder 108 and decoder 110. Pretrained encoder 108 may be provided source utterance 102 as an input to generate a vector representation of source utterance 102. This pretrained encoder 108 may generate representations that is good at extracting features of the content of the input utterance (e.g., the semantics). For example, pretrained encoder 108 may be a wav2Vec (W2V) model as described in Baevski et al., wav2vec 2.0: A framework for self-supervised learning of speech representations, Advances in neural information processing systems, vol. 33, pp. 12449-12460, 2020.

Decoder 110 may be provided the vector representation of source utterance 102 output by encoder 106 as an input to generate another vector representation of the source utterance. Decoder 110 may transform the source utterance 102 vector representation into a representation more similar to the output of encoder 108. Decoder 110 may include, for example, two layers of up-sampled CNN. In some embodiments, loss 122 may be computed by a Euclidean distance between the output of pretrained encoder 108 and the output of the last CNN layer of decoder 110.

In some embodiments, due to model structures and other computational parameters (e.g., kernel size or dilation size) of pretrained encoder 108 may cause differences in alignment between the outputs of pretrained encoder 108 and decoder 110. To combat this, in some embodiments, loss 122 may be computed as a differentiable dynamic time warping (DTW) loss between the output of pretrained encoder 108 and decoder 110. For example, loss 122 may be a DTW loss as described in Cuturi et al., Soft-dtw: a differentiable loss function for time-series, International conference on machine learning, PMLR, pp. 894-903, 2017. Utilizing a DTW based loss for loss 122 allows for comparison of the two representations even if the length of the two time series data is different. Further, if it is a similar pattern between the two representations but there is a time shift, DTW still provides a good basis for a loss function, where Euclidean distance may not provide good results. In some embodiments, a DTW loss may utilize the Euclidean distance to find the optimal warping path.

Although the represented features per each temporal sequence between the outputs of pretrained encoder 108 and decoder 110 are different, their sequences can be aligned since they are driven by the same utterance and Euclidean distance can be computed as a distance metric in some embodiments. Loss 122 may encourage encoder 106 to try to capture linguistic features and eliminate the spoken style of a source utterance.

Losses 123 and 124 are based on adversarial networks (i.e., GAN) of discriminator 114 and source classifier 116. Discriminator 114 may be a neural network based model that is trained to discriminate whether an utterance is real or fake (i.e., an actual recorded utterance or a generated utterance). Discriminator 114 may be trained in alternating fashion with encoder 106, decoder 112, encoder 120, decoder 110, and/or filter generator 118 in order to adversarially improve their capability in generating generated utterances 126 that are indistinguishable from actual utterances. For example, during training, discriminator 114 may be randomly given either a source utterance 102 or a generated utterance 126 as an input, and output a prediction of real/fake (i.e., as a value representing a probability). Loss 123 may be computed based on a comparison of the prediction of discriminator 114 with an indication of real/fake provided by the system in response to selecting a source utterance 102 or a generated utterance 126 as the input. In some embodiments, the generative aspects of framework 100 (i.e., parameters of encoder 106, decoder 112, encoder 120, decoder 110, and/or filter generator 118) are updated according to a first loss function, and discriminator 114 is updated alternately according to a second loss function. The first loss function may be represented as:

$$\begin{matrix}min \\ G , S , M\end{matrix} {L}_{adv} + {λ}_{advcls} {L}_{advcls} + {λ}_{sty} {L}_{sty} - {λ}_{ds} {L}_{ds} + {λ}_{cyc} {L}_{cyc} + {λ}_{DTW} {L}_{DTW}$$

where L_{adv} represents the adversarial loss associated with discriminator 114 (e.g., loss 123), L_{advcls} represents the adversarial loss associated with source classifier 116 (e.g., loss 124), L_{sty} represents a style reconstruction loss, L_{ds} represents a style diversification loss, L_{cyc} represents a cycle consistency loss, and L_{DTW} represents a dynamic time warping loss (e.g., loss 122). The variables labeled by λ denotes weight applied to the respective losses, and may be configured as a hyperparameter. In some embodiments, losses L_{sty}, L_{ds}, and L_{cyc} may be as described in Li et al., Starganv2-vc: A diverse, unsupervised, non-parallel framework for natural-sounding voice conversion, arXiv:2107.10394, 2021. The loss function when training the discriminator 114 may be represented as:

$$\begin{matrix}min \\ C , D\end{matrix} {L}_{adv} + {λ}_{sc} {L}_{sc}$$

Source classifier 116 may be a neural network based model that is trained to discriminate the source of an utterance (e.g., from a source utterance domain or a target utterance domain). Source classifier 116 may be trained together with encoder 106, decoder 112, and/or filter generator 118 in order to adversarially improve their capability in generating utterance that are predicted by source classifier 116 to be from the source utterance domain. This adversarial learning can help to improve the style similarity between the target utterance 104 and the generated utterance 126. In some embodiments, loss 124 is a soft-max function. However, in some embodiments, the soft-max function induces wide embedding space per each speaker by source classifier 116, where a margin among the classes is small, and it might hinder the adversarial training, as a risk region may exist where embedding vectors are produces located around the decision boundary. This may result in unnatural speech and speech less similar to the target speaker.

To mitigate the low confidence sample problem, loss 124 may be implemented as an additive angular margin (AAM) loss to enhance the discriminability of the source classifier 116. AAM loss may utilize the arc-cosine function to calculate the angle between the current feature and the target weight. Afterward, an additive angular margin may be added to the target angle, and a target logit is computed by a cosine function. All logits may be re-scaled by a fixed feature norm. Subsequent steps of AAM loss may be the same as in a softmax loss. AAM loss may be implemented, for example, as described in Deng et al., Arcface: Additive angular margin loss for deep face recognition, Proceedings of the IEEE/CVF conference on computer vision and pattern recognition, pp. 4690-4699, 2019. AAM loss for loss 124 enhances the margin of source classifier 116 as embedding vectors are centered on class centroids. This learning benefit delivers tight decision boundaries for adversarial learning and the decoder 112 is further trained to combat an enhanced source classifier 116.

Training of components of framework 100 may be performed according to losses 122-124. For example, parameters of encoder 106, filter generator 118, decoder 110, decoder 112, discriminator 114, and/or source classifier 116 may be updated via backpropagation based on gradients computed according to losses 122-124. Losses 122-124 may be used in combination my weighting and summing the individual losses, where the weights may be configurable hyperparameters. In some embodiments, training may be performed in multiple stages. Training may be performed in an unsupervised manner without label information. The proposed method is also a GAN-based model, and learning is conducted in a data environment without label information, or in other words in an unsupervised manner. Here, no label means that there is no ground truth for the converted output (e.g., an output Mel-spectrogram).

FIG. 2A is a simplified diagram of an exemplary filter generator 118, according to some embodiments. Illustrated in FIG. 2A for context, target utterance 104 is input to encoder 120 to generate a vector representation of target utterance 104. The vector representation of target utterance 104 is input to filter generator 118. Filter generator 118 may include, as illustrated, three attentive pooling encoders 202, 204, and 206. An exemplary attentive pooling encoder is described in FIG. 2B. Attentive pooling 202 may be trained to generated weight vector Wₛ based on the vector representation of target utterance 104. Attentive pooling 204 may be trained to generated bias vector W_{b} based on the vector representation of target utterance 104. Attentive pooling 206 may be trained to generated speaker embedding vector S based on the vector representation of target utterance 104. Weight vector Wₛ, bias vector W_{b}, and speaker embedding vector S may be combined to generate a dynamic style embedding (DSE) 212. For example, DSE 212 may be computed as Wₛ×S+W_{B}. Here, the weight vector Wₛ and speaker embedding have the same dimension of vector. The dynamic style embedding 212 may be used in computing loss functions in place of the style vector as described herein.

DSE 212 may be passed through a trainable linear layer 213 to generate dynamic weights 208. DSE 212 may also be passed through a separately trainable linear layer 214 to generate dynamic biases 210. Together, dynamic weights 208 and dynamic biases 210 may be a generated filter that may be applied to a source utterance, e.g., via decoder 112 in FIG. 1. Since weights 208 and biases 210 are generated at inference based on the target utterance 104, this provides a dynamic filter that is not frozen in the inference process. In some embodiments, linear layers 213-214 are part of filter generator 118. In some embodiments, linear layers 213-214 are part of decoder 112 such that DSE 212 is input to decoder 112 which internally generates dynamic weights and biases based on DSE 212 via linear layers so that the dynamic weights and biases may control the ADAIN layers as discussed below.

Returning to the discussion of FIG. 1, decoder 112 may generate generated utterance 126 based on the vector representation of source utterance 102 conditioned by the dynamic style embeddings generated by filter generator 118 based on target utterance 104. Decoder 112 may be a neural network based model that may include multiple layers. For example, layers of decoder 112 may include one or more instance normalization (IN) layers, one or more activation layers (e.g., ReLU layers), and one or more convolution layers. An instance normalization (IN) layer may take input data from a prior layer, normalize it, and send the normalized data to the next layer. The normalization may include normalizing data according to the data's mean and variance. For example, for a two-dimensional input data x of dimensions H×W, the mean may be computed as:

$$μ = \frac{1}{HW} {\sum }_{l = 1}^{W} {\sum }_{m = 1}^{H} {x}_{lm}$$

And the variance may be computed as:

$${σ}^{2} = \frac{1}{HW} {\sum }_{l = 1}^{W} {\sum }_{m = 1}^{H} {( {x}_{lm -} μ )}^{2}$$

Using the computed mean and variance, each spatial dimension may be normalized according to:

$$y = \frac{x - μ}{\sqrt{{σ}^{2}}}$$

The normalized outputs may be scaled and have a bias applied, where the scaling and bias parameters may be learned. In general, the scaling and bias preserves the networks ability to perform an identity function (i.e., the output equals the input). In some embodiments, one or more normalization layers of decoder 112 may be replaced with adaptive instance normalization (AdaIN) layers. In an AdaIN layer, the scaling and bias parameters are not learnable parameters of the decoder 112, but rather are computed based on a style input. For example, an AdaIN function may be computed as:

$$AdaIN ( x , s ) = σ ( s ) ( \frac{x - μ ( x )}{σ ( x )} ) + μ ( s )$$

where x represents the content input, and s represents the style input. Here, the scaling and bias parameters are generated by the dynamic style embeddings of filter generator 118. This may be interpreted as aligning the mean and variance of the input to the mean and variance of the style. In some embodiments, dynamic weights 208 may be used as the scaling factor σ(s), and dynamic biases 210 may be used as the bias factor μ(s). This computation may be performed individually for each channel of a multi-channel input. For example, encoder 102 may generate a multi-channel vector representation of source utterance 102, and decoder 112 may apply dynamically generated weight and bias vectors to each channel of the vector representation, where each channel may have different generated weights and biases as generated by filter generator 118.

FIG. 2B is a simplified diagram of an exemplary attentive pooling model 250, according to some embodiments. In some embodiments, attentive pooling models 202, 204, and 206 may be attentive pooling models 250. Input embedding (x) 215 may be, for example, the output of encoder 120, which is provided as the input to each of attentive pooling models 202, 204, and 206. While each of these attentive pooling models have the same input, they have individual parameters that are updated according to how they are used in the corresponding loss functions to which they contribute.

Attentive pooling 250 may generate an integrated feature vector by estimating weights according to the importance of input features. Attentive pooling 250 as illustrated includes a number of neural network layers. These neural network layers are exemplary, and additional layers, fewer layers, different ordering, etc. may be utilized. The following description describes the exemplary layers of attentive pooling 250 as illustrated. Input embedding (x) 215 may be input to attentive pooling 250 in addition to a computed mean and standard deviation of x. In some embodiments, input embedding (x) 216, the mean of x, and the standard deviation of x are concatenated together to form the input to attentive pooling 250. Attentive pooling 250 may include a convolution layer 216, a Relu activation layer 218, an instance normalization layer 220, a Tan h activation layer 222, a convolution layer 224, and a softmax layer 226. These layers may be used in order to generate a weight vector (w) 228. Weight vector (w) 228 may be used to weight the mean and standard deviation of input embedding (x) 215. This weighted mean and standard deviation may be input to a layer normalization layer 230, linear layer 232, and layer normalization 234. The output of layer normalization 234 may be an output embedding (i.e., vector representation) 236. Output embedding 236 may be weight vector Wₛ, bias vector W_{b}, or speaker embedding vector S respectively for attentive pooling models 202, 204, and 206.

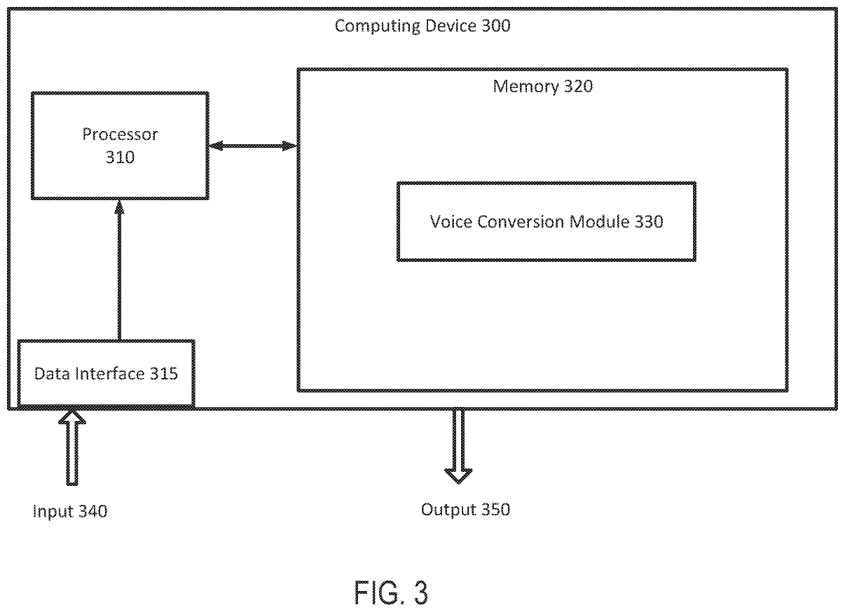

FIG. 3 is a simplified diagram illustrating a computing device 300 implementing the framework described herein, according to some embodiments. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of transitory or non-transitory machine-readable media (e.g., computer-readable media). Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for voice conversion module 330 that may be used to implement and/or emulate the systems and models, and/or to implement any of the methods described further herein.

Voice conversion module 330 may receive input 340 such as user input, training data, model parameters, source utterances, target utterances, etc. and generate an output 350 such as generated utterances. For example, voice conversion module 330 may be configured to generate an utterance audio based on a source utterance using the style of a target utterance as described herein.

The data interface 315 may comprise a communication interface, a user interface (such as a voice input interface, a graphical user interface, and/or the like). For example, the computing device 300 may receive the input 340 from a networked device via a communication interface. Or the computing device 300 may receive the input 340, such as source utterances, from a user via the user interface.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

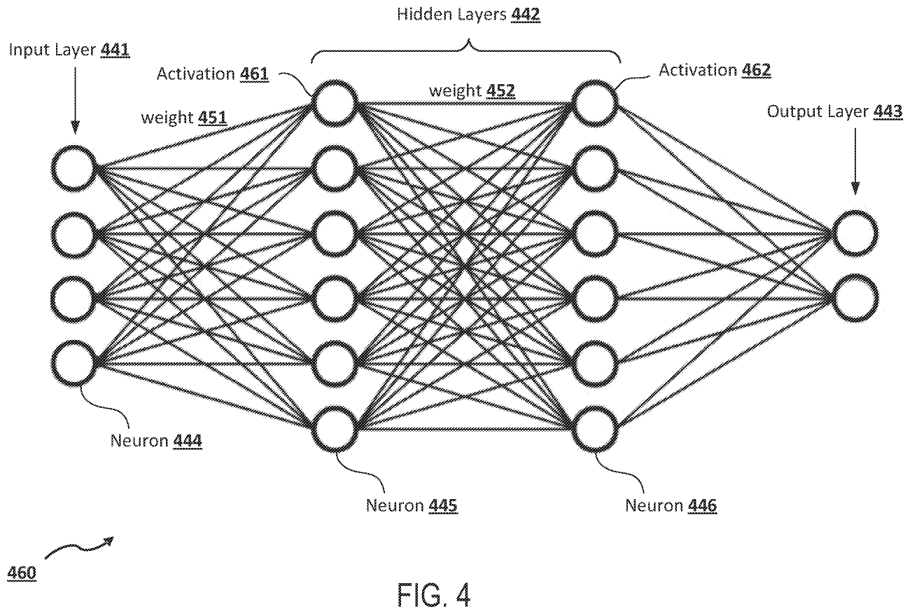

FIG. 4 is a simplified diagram illustrating the neural network structure, according to some embodiments. In some embodiments, the voice conversion module 330 may be implemented at least partially via an artificial neural network structure shown in FIG. 4. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data such as training data, user input data, vectors representing latent features, etc. The number of nodes (neurons) in the input layer 441 may be determined by the dimensionality of the input data (e.g., the length of a vector of the input). Each node in the input layer represents a feature or attribute of the input.

The hidden layers 442 are intermediate layers between the input and output layers of a neural network. It is noted that two hidden layers 442 are shown in FIG. 4 for illustrative purpose only, and any number of hidden layers may be utilized in a neural network structure. Hidden layers 442 may extract and transform the input data through a series of weighted computations and activation functions.

For example, as discussed in FIG. 3, the voice conversion module 330 receives an input 340 and transforms the input into an output 350. To perform the transformation, a neural network such as the one illustrated in FIG. 4 may be utilized to perform, at least in part, the transformation. Each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the voice conversion module 330 may comprise the transformative neural network structure of layers of neurons, and weights and activation functions describing the non-linear transformation at each neuron. Such a neural network structure is often implemented on one or more hardware processors 310, such as a graphics processing unit (GPU).

In one embodiment, the voice conversion module 330 may be implemented by hardware, software and/or a combination thereof. For example, the voice conversion module 330 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based voice conversion module 330 may be trained by iteratively updating the underlying parameters (e.g., weights 451, 452, etc., bias parameters and/or coefficients in the activation functions 461, 462 associated with neurons) of the neural network based on a loss function. For example, during forward propagation, the training data such as known-good triplets of source utterance, target utterance, and generated utterance are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding utterance) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as voice conversion using an unseen target utterance.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 4 is exemplary. For example, different neural network structures may be utilized, and additional neural-network based or non-neural-network based component may be used in conjunction as part of module 330. For example, a text input may first be embedded by an embedding model, a self-attention layer, etc. into a feature vector. The feature vector may be used as the input to input layer 441. Output from output layer 443 may be output directly to a user or may undergo further processing. For example, the output from output layer 443 may be decoded by a neural network based decoder. The neural network illustrated in FIG. 400 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by module 330. The trained neural network thus improves neural network technology in voice conversion.

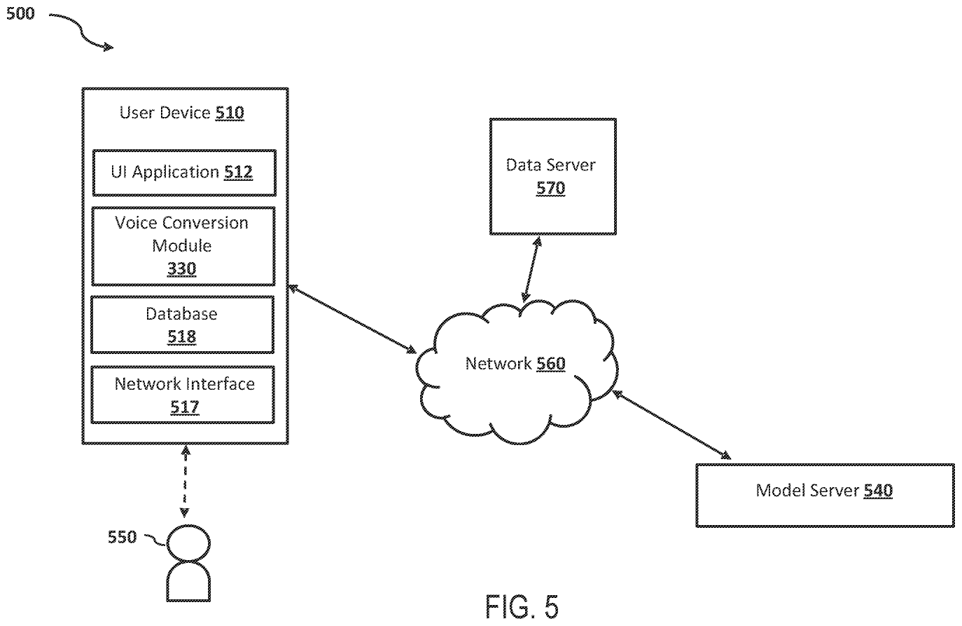

FIG. 5 is a simplified block diagram of a networked system 500 suitable for implementing the framework described herein. In one embodiment, system 500 includes the user device 510 (e.g., computing device 300) which may be operated by user 550, data server 570, model server 540, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3, operating an OS such as a MICROSOFT® OS, a UNIX® OS, a LINUX® OS, a real-time operation system (RTOS), or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities. In some embodiments, user device 510 is used in training neural network based models. In some embodiments, user device 510 is used in performing inference tasks using pre-trained neural network based models (locally or on a model server such as model server 540).

User device 510, data server 570, and model server 540 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560. User device 510, data server 570, and/or model server 540 may be a computing device 300 (or similar) as described herein.

In some embodiments, all or a subset of the actions described herein may be performed solely by user device 510. In some embodiments, all or a subset of the actions described herein may be performed in a distributed fashion by various network devices, for example as described herein.

User device 510 may be implemented as a communication device that may utilize appropriate hardware and software configured for wired and/or wireless communication with data server 570 and/or the model server 540. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and voice conversion module 330, which may correspond to executable processes, procedures, and/or applications with associated hardware. For example, the user device 510 may allow a user to modify a source utterance with the style of a target utterance. In other embodiments, user device 510 may include additional or different modules having specialized hardware and/or software as required.

In various embodiments, user device 510 includes other applications as may be desired in particular embodiments to provide features to user device 510. For example, other applications may include security applications for implementing client-side security features, programmatic client applications for interfacing with appropriate application programming interfaces (APIs) over network 560, or other types of applications. Other applications may also include communication applications, such as email, texting, voice, social networking, and IM applications that allow a user to send and receive emails, calls, texts, and other notifications through network 560.

Network 560 may be a network which is internal to an organization, such that information may be contained within secure boundaries. In some embodiments, network 560 may be a wide area network such as the internet. In some embodiments, network 560 may be comprised of direct physical connections between the devices. In some embodiments, network 560 may represent communication between different portions of a single device (e.g., a communication bus on a motherboard of a computation device).

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

User device 510 may further include database 518 stored in a transitory and/or non-transitory memory of user device 510, which may store various applications and data (e.g., model parameters) and be utilized during execution of various modules of user device 510. Database 518 may store source utterances, target utterances, model parameters, etc. In some embodiments, database 518 may be local to user device 510. However, in other embodiments, database 518 may be external to user device 510 and accessible by user device 510, including cloud storage systems and/or databases that are accessible over network 560 (e.g., on data server 570).

User device 510 may include at least one network interface component 517 adapted to communicate with data server 570 and/or model server 540. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 570 may perform some of the functions described herein. For example, data server 570 may store a training dataset including known good pairs of utterances, etc. Data server 570 may provide data to user device 510 and/or model server 540. For example, training data may be stored on data server 570 and that training data may be retrieved by model server 540 while training a model stored on model server 540.

Model server 540 may be a server that hosts models described herein. Model server 540 may provide an interface via network 560 such that user device 510 may perform functions relating to the models as described herein (e.g., encoder 106, encoder 120, pretrained encoder 108, decoder 110, decoder 112, filter generator 118, discriminator 114, source classifier 116, etc.). Model server 540 may communicate outputs of the models to user device 510 via network 560. User device 510 may display model outputs, or information based on model outputs, via a user interface to user 550.

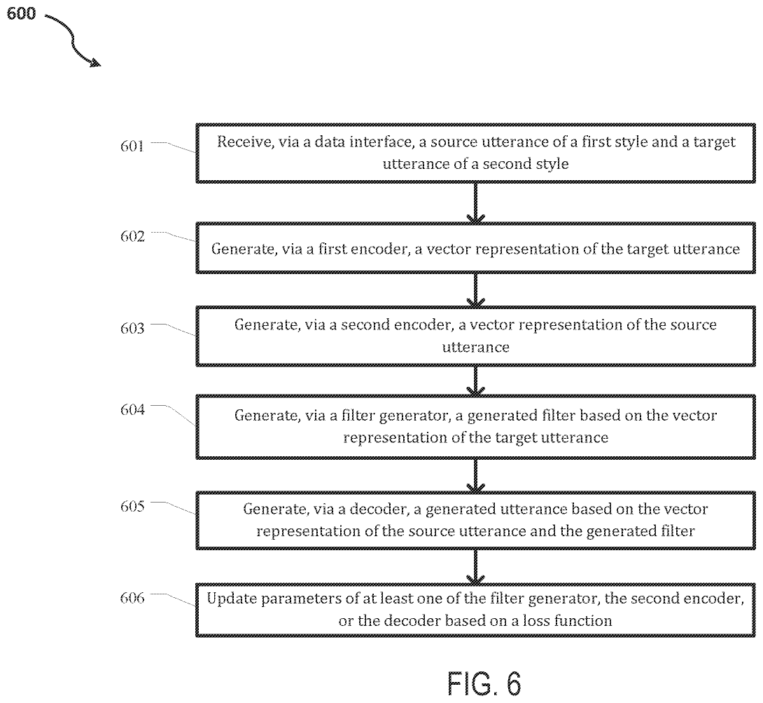

FIG. 6 is an example logic flow diagram, according to some embodiments described herein. One or more of the processes of method 600 may be implemented, at least in part, in the form of executable code stored on non-transitory, tangible, machine-readable media that when run by one or more processors may cause the one or more processors to perform one or more of the processes (e.g., computing device 300). In some embodiments, method 600 corresponds to the operation of the voice conversion module 330 that performs style conversion of a source utterance using the style of a target utterance as described in FIGS. 1-2B.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 601, a system (e.g., computing device 300, user device 510, model server 540, device 700, or device 715) receives, via a data interface (e.g., data interface 315, network interface 517, or an interface to a microphone sensor) a source utterance (e.g., source utterance 102) of a first style and a target utterance (e.g., target utterance 104) of a second style.

At step 602, the system generates, via a first encoder (e.g., encoder 120), a vector representation of the target utterance.

At step 603, the system generates, via a second encoder (e.g., encoder 106), a vector representation of the source utterance.

At step 604, the system generates, via a filter generator (e.g., filter generator 118), a generated filter based on the vector representation of the target utterance. In some embodiments, the generated filter includes a weight vector and a bias vector. The weight vector and bias vectors may be generated by attentive pooling models as described in FIGS. 1-2B.

At step 605, the system generates, via a decoder (e.g., decoder 112), a generated utterance (e.g., generated utterance 126) based on the vector representation of the source utterance and the generated filter. In some embodiments, the generating the generated utterance includes applying the dynamic style embeddings to an adaptive instance normalization layer of the decoder.

At step 606, the system updates parameters of at least one of the filter generator, the second encoder, or the decoder based on a loss function (e.g., losses 122-124). In some embodiments, parameters of the filter generator, the second encoder, or the decoder may be updated based on one or more loss functions. For example, the system may generate, via a discriminator (e.g., discriminator 114), a first prediction of real or fake based on the generated utterance or the source utterance. A first loss function (e.g., loss 123) may be computed based on the first prediction and an indication of real or fake as described in FIG. 1. In another example, the system may generate, via a source classifier (e.g., source classifier 116) a second prediction of utterance source based on the generated utterance. A second loss function (e.g., loss 124) may be computed based on the second prediction. The second loss function may be, for example, an additive angular margin loss. In another example, the system may generate, via pretrained encoder model (e.g., pretrained encoder 108), a second vector representation of the source utterance. A third loss function (e.g., loss 122) may be computed based on a comparison of the second vector representation of the source utterance with the first vector representation of the source utterance. For example, dynamic time warping may be used to perform the comparison. The first, second, and third loss functions may be used alone or in combination to update the parameters.

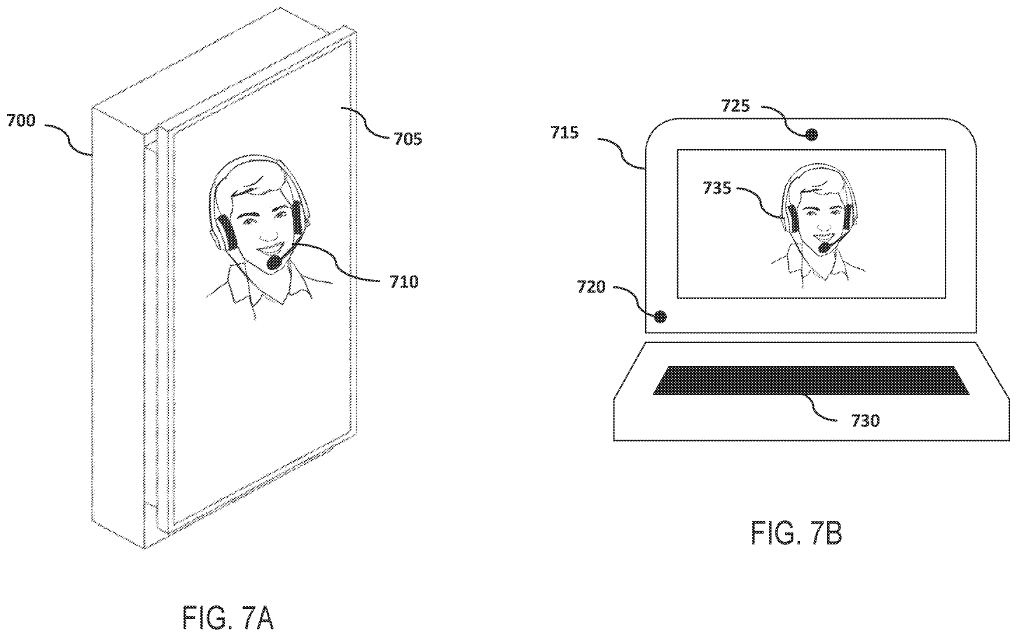

FIG. 7A is an exemplary device 700 with a digital avatar interface, according to some embodiments. Device 700 may be, for example, a kiosk that is available for use at a store, a library, a transit station, etc. Device 700 may display a digital avatar 710 on display 705. In some embodiments, a user may interact with the digital avatar 710 as they would a person, using voice and non-verbal gestures. Digital avatar 710 may interact with a user via digitally synthesized gestures, digitally synthesized voice, etc. For example, the voice of digital avatar 710 may be generated by voice conversion using a sample target utterance representing a desired voice style, and a source utterance received via a data interface using methods described herein.

Device 700 may include one or more microphones, and one or more image-capture devices (not shown) for user interaction. Device 700 may be connected to a network (e.g., network 560). Digital Avatar 710 may be controlled via local software and/or through software that is at a central server accessed via a network. For example, an AI model may be used to control the behavior of digital avatar 710, and that AI model may be run remotely. In some embodiments, device 700 may be configured to perform functions described herein (e.g., via digital avatar 710). For example, device 700 may perform one or more of the functions as described with reference to computing device 300 or user device 510. For example, the voice of digital avatar 735 may be generated by voice conversion using a sample target utterance representing a desired voice style, and a source utterance received via a data interface using methods described herein.

FIG. 7B is an exemplary device 715 with a digital avatar interface, according to some embodiments. Device 715 may be, for example, a personal laptop computer or other computing device. Device 715 may have an application that displays a digital avatar 735 with functionality similar to device 700. For example, device 715 may include a microphone 720 and image capturing device 725, which may be used to interact with digital avatar 735. In addition, device 715 may have other input devices such as a keyboard 730 for entering text.

Digital avatar 735 may interact with a user via digitally synthesized gestures, digitally synthesized voice, etc. Voice synthesis may be performed as described in FIGS. 1-6. In some embodiments, device 715 may be configured to perform functions described herein (e.g., via digital avatar 735). For example, device 715 may perform one or more of the functions as described with reference to computing device 300 or user device 510. For example, voice conversion using input source and target utterances.

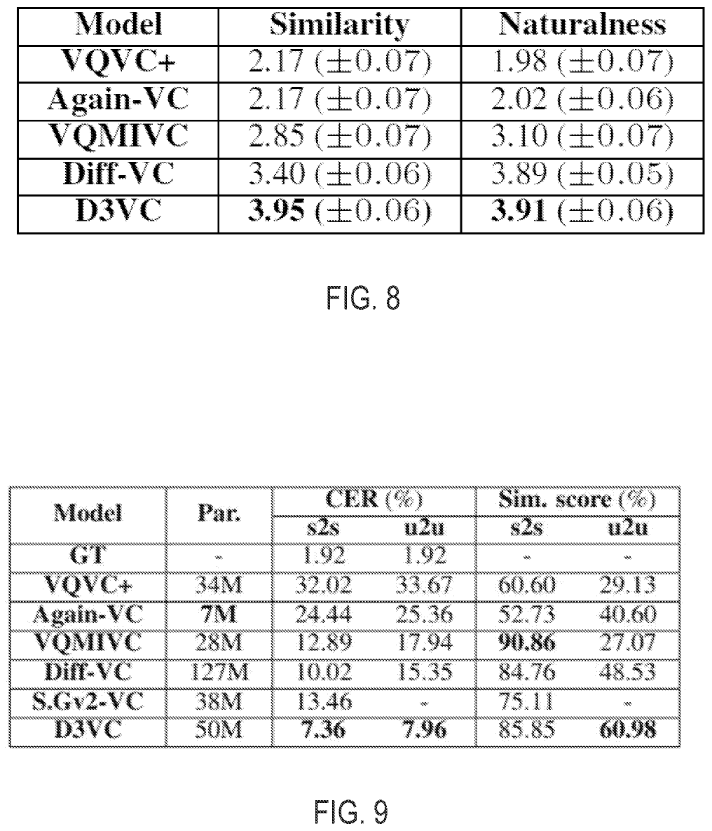

FIGS. 8-11 provide charts illustrating exemplary performance of different embodiments described herein. Evaluation was performed with both subjective and objective metrics. Experiments used a pre-trained Parallel WaveGAN to synthesize waveforms from mel-spectrogram. Parallel WaveGAN is described in Yamamoto et al., Parallel wavegan: A fast waveform generation model based on generative adversarial networks with multi-resolution spectrogram, ICASSP 2020-2020 IEEE International Conference on Acoustics, Speech and Signal Processing (ICASSP), pp. 6199-6203, 2020. Converted waveforms were downsampled to 16 kHz for the comparisons.

For subjective metrics, unseen source speakers to unseen target speakers (u2u) was utilized to evaluate Mean Opinion Score (MOS). Among the blind speakers, randomly selected utterances produced 40 pairs. For an evaluation metric, the similarity and naturalness was evaluated on a scale of 1 to 5, where 1 indicated completely distorted and unnatural while 5 indicates completely similar and clear.

For objective metrics, an Automatic Speaker Verification (ASV) model was used and an Automatic Speech Recognition (ASR) model. In ASV, the similarity score was measured between the converted speech and target speech by the speaker model. If the similarity score is greater than 0.7, 1 point is given, and 0 points otherwise. The speaker score means the sum of the scores divided by the number of total examples. In ASR, Character Error Rate (CER) was used for the evaluation metric. Experiments utilized three evaluation protocols (VCTK s2s, VCTK u2u, and TTS u2u). For the VCTK s2s, conversion pairs were randomly selected among the evaluation data in the trained speakers. For VCTK u2u, conversion pairs among the blind speakers were randomly selected. VCTK s2s and VCTK u2u have 4 groups (m2m, m2w, w2m, w2w) and each group has 10 k pairs, respectively. For TTS u2u, fastspeech2 model trained by self-organized woman corpus produces 360 examples for source utterances, and randomly selected 3600 samples among the blind speakers in VCTK are used as target speakers. TTS u2u has 2 groups (w2w and w2m) and each group has 1800 pairs. The fastspeech2 model is described in Ren et al., Fastspeech 2: Fast and high-quality end-to-end text to speech, arXiv: 2006.04558, 2020.

FIG. 8 illustrates the results of subjective tests conducted by 21 people and averaging results with 95% confidence intervals. The embodiments used shows better performance than the existing methods in both similarity and naturalness aspects. In particular, comparing diffusion-VC with our method, it shows similar results to diffusion-VC in terms of naturalness, while it shows much better performance in terms of similarity.

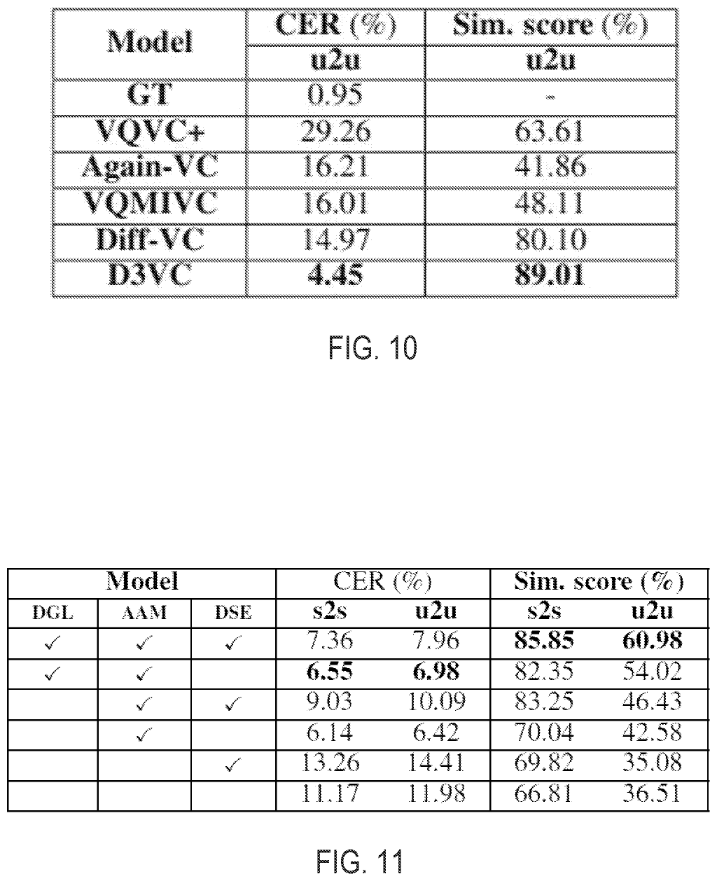

FIGS. 9 and 10 present the comparative results of the objective metrics.

FIG. 9 illustrates VQVC+ and Again-VC showed lower performance in terms of CER than the existing methods in both s2s and u2u protocols. VQMIVC is improved in terms of CER compared to VQVC+ and Again-VC, while the similarity score for unseen speaker conversion is very low. On the other hand, the tested embodiment of the framework described herein showed superior performance in terms of similarity score and CER compared to existing methods in both seen-to-seen and unseen-to-unseen environments. Especially, compared with diffusion-VC methods, the similarity score in s2s shows similar results, while one in u2u shows improved performance. Also, in the method described herein, the performance difference between s2s and u2u in terms of CER is very small. That is, the method described herein is superior to the existing method in the any-to any environment and shows stable performance. In addition, compared to existing methods VQVC+, the number of parameters of the proposed model did not increase rapidly, and it was smaller than diffusion-VC.

FIG. 10 illustrates the results of using the voice synthesized by TTS as the source utterance. Even when using TTS voice, the method described herein showed better results than other existing methods.

FIG. 11 illustrates an ablation study to compare the effect of different embodiments described herein. FIG. 11 shows that leveraging DSE alone shows degraded CER and similarity score in u2u since the dynamic filter process is difficult to be generalized and some embedding values may contain meaningless information. Jointly applying AAM softmax and DSE, on the other hand, shows improved performance over the AAM softmax model. As AAM softmax enhances the adversarial training, DSE is better generalized to both trained speakers and blind speakers. Although the performance of CER still remains a limitation, applying DSE is more helpful in terms of VC similarity, and jointly trained with DGL delivers significant performance improvement to the blind speakers.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of voice conversion, the method comprising:
receiving, via a data interface, a source utterance of a first style and a target utterance of a second style;
generating, via a first encoder, a vector representation of the target utterance;
generating, via a second encoder, a vector representation of the source utterance;
generating, via a filter generator, a generated filter based on the vector representation of the target utterance; and
generating, via a decoder, a generated utterance based on the vector representation of the source utterance and the generated filter.

2. The method of claim 1, wherein the generating the generated utterance includes applying the generated filter to an adaptive instance normalization layer of the decoder.

3. The method of claim 1, wherein the generated filter includes a weight vector and a bias vector.

4. The method of claim 3, wherein:
the weight vector is generated via a first attentive pooling model based on the vector representation of the target utterance, and
the bias vector is generated via a second attentive pooling model based on the vector representation of the target utterance.

5. The method of claim 1, further comprising:
generating, via a discriminator, a first prediction of real or fake based on the generated utterance or the source utterance;
computing a first loss function based on the first prediction and an indication of real or fake; and
updating parameters of at least one of the filter generator, the second encoder, or the decoder based on the first loss function.

6. The method of claim 5, further comprising:
generating, via a source classifier, a second prediction of utterance source based on the generated utterance;
computing a second loss function based on the second prediction, the second loss function being an additive angular margin loss; and
updating parameters of at least one of the filter generator, the second encoder, or the decoder further based on the second loss function.

7. The method of claim 6, wherein the vector representation of the source utterance is a first vector representation of the source utterance, further comprising:
generating, via a pretrained encoder model, a second vector representation of the source utterance;
computing a third loss function based on a comparison of the first and second vector representations of the source utterance; and
updating parameters of at least one of the filter generator, the second encoder, or the decoder further based on the third loss function.

8. A system for voice conversion, the system comprising:
a memory that stores a plurality of processor executable instructions;
a data interface that receives a source utterance of a first style and a target utterance of a second style; and
one or more hardware processors that read and execute the plurality of processor-executable instructions from the memory to perform operations comprising:
generating, via a first encoder, a vector representation of the target utterance;
generating, via a second encoder, a vector representation of the source utterance;
generating, via a filter generator, a generated filter based on the vector representation of the target utterance; and
generating, via a decoder, a generated utterance based on the vector representation of the source utterance and the generated filter.

9. The system of claim 8, wherein the generating the generated utterance includes applying the generated filter to an adaptive instance normalization layer of the decoder.

10. The system of claim 8, wherein the generated filter includes a weight vector and a bias vector.

11. The system of claim 10, wherein:
the weight vector is generated via a first attentive pooling model based on the vector representation of the target utterance, and
the bias vector is generated via a second attentive pooling model based on the vector representation of the target utterance.

12. The system of claim 8, the operations further comprising:
generating, via a discriminator, a first prediction of real or fake based on the generated utterance or the source utterance;
computing a first loss function based on the first prediction and an indication of real or fake; and
updating parameters of at least one of the filter generator, the second encoder, or the decoder based on the first loss function.

13. The system of claim 12, the operations further comprising:
generating, via a source classifier, a second prediction of utterance source based on the generated utterance;
computing a second loss function based on the second prediction, the second loss function being an additive angular margin loss; and
updating parameters of at least one of the filter generator, the second encoder, or the decoder further based on the second loss function.

14. The system of claim 13, wherein the vector representation of the source utterance is a first vector representation of the source utterance, the operations further comprising:
generating, via a pretrained encoder model, a second vector representation of the source utterance;
computing a third loss function based on a comparison of the first and second vector representations of the source utterance; and
updating parameters of at least one of the filter generator, the second encoder, or the decoder further based on the third loss function.

15. A non-transitory machine-readable medium comprising a plurality of machine-executable instructions which, when executed by one or more processors, are adapted to cause the one or more processors to perform operations comprising:
receiving, via a data interface, a source utterance of a first style and a target utterance of a second style;
generating, via a first encoder, a vector representation of the target utterance;
generating, via a second encoder, a vector representation of the source utterance;
generating, via a filter generator, a generated filter based on the vector representation of the target utterance; and
generating, via a decoder, a generated utterance based on the vector representation of the source utterance and the generated filter.

16. The non-transitory machine-readable medium of claim 15, wherein the generating the generated utterance includes applying the generated filter to an adaptive instance normalization layer of the decoder.

17. The non-transitory machine-readable medium of claim 15, wherein the generated filter includes a weight vector and a bias vector.

18. The non-transitory machine-readable medium of claim 17, wherein:
the weight vector is generated via a first attentive pooling model based on the vector representation of the target utterance, and
the bias vector is generated via a second attentive pooling model based on the vector representation of the target utterance.

19. The non-transitory machine-readable medium of claim 15, the operations further comprising:
generating, via a discriminator, a first prediction of real or fake based on the generated utterance or the source utterance;
computing a first loss function based on the first prediction and an indication of real or fake; and
updating parameters of at least one of the filter generator, the second encoder, or the decoder based on the first loss function.

20. The non-transitory machine-readable medium of claim 19, wherein the vector representation of the source utterance is a first vector representation of the source utterance, the operations further comprising:
generating, via a source classifier, a second prediction of utterance source based on the generated utterance;
computing a second loss function based on the second prediction, the second loss function being an additive angular margin loss; and
updating parameters of at least one of the filter generator, the second encoder, or the decoder further based on the second loss function;
generating, via a pretrained encoder model, a second vector representation of the source utterance;
computing a third loss function based on a comparison of the first and second vector representations of the source utterance; and
updating parameters of at least one of the filter generator, the second encoder, or the decoder further based on the third loss function.
